(19) United States
(12) Patent Application Publication
(10) Pub. No.: US 2016/0275638 A1
(43) Pub. Date: Sep. 22, 2016

(54) VEHICLE SERVICE REQUEST SYSTEM HAVING ENHANCED SAFETY FEATURES

(71) Applicants: David M. Korpi, Pacific Grove, CA (US); Stephen W. Aycock, II, Lakeland, FL (US)

(72) Inventors: David M. Korpi, Pacific Grove, CA (US); Stephen W. Aycock, II, Lakeland, FL (US)

(21) Appl. No.: 15/075,138

(22) Filed: Mar. 19, 2016

Related U.S. Application Data
(60) Provisional application No. 62/135,745, filed on Mar. 20, 2015.

(51) Int. Cl. G06Q 50/30; G06Q 50/00; H04M 1/725

(52) U.S. Cl. CPC G06Q 50/30; H04M 1/72522; G06Q 50/01

(57) ABSTRACT

Methods, systems and computer readable media for computerized vehicle service request systems having enhanced safety features are described.

### RELATED APPLICATIONS

This application claims the benefit of U.S. Provisional Application No. 62/135,745, entitled “Improved Mobile Vehicle Request System Utilizing Photos of Pickup Vehicles” filed on Mar. 20, 2015, which is incorporated herein by reference in its entirety.

### TECHNICAL FIELD

Embodiments relate generally to computerized vehicle service request systems, and more particularly, to methods, systems and computer readable media for computerized vehicle service request systems having enhanced safety features.

### BACKGROUND

In the field of passenger vehicle service providers, such as Yellow Taxi, Uber and the like, there may exist a need for increasing a level of safety and security in order to help users of such services feel safer when using such services. For example, in large cities, such as New York, when a user hails a “Yellow Taxi,” which is a brand the user may have come to know well over time, the user has a high level of confidence that Yellow Taxis are safe to enter and therefore may not hesitate to enter into a Yellow Taxi vehicle and use the service.

Security and safety issues have developed in connection with the arrival and growth of online transportation networks, such as Uber, which develop, market and operate a mobile application, which allows consumers with smartphones to submit a trip request, which is then routed to a driver who uses their own car to provide transportation services for the user. One challenge to safety is for users to feel comfortable entering into a vehicle that may only be described by the operator of the vehicle as a “2001 Blue Toyota Celica.” One issue may be that a user may not be able to tell the difference between a 2001 Toyota Celica and other different makes and models of small blue cars.

While some “Uber type” mobile applications may include photos of the drivers, these systems may not include a photo of the vehicle that the driver is using. A need may exist to permit a passenger to readily identify both the vehicle and driver as well as optionally indicating to the driver that the passenger entering is indeed the one in contract. Additionally, there may exist a need for a driver to feel secure that the person entering the vehicle is indeed the one in contract, for example by having a picture of the passenger provided through the vehicle service request system.

Embodiments were conceived in light of the above mentioned needs, problems and/or limitations, among other things.

### SUMMARY

Some implementations can include an improved vehicle service request system that includes a photo of the car that will be used to pick the passenger up and/or a photo of the driver.

Some implementations can include a method comprising receiving, from a first user interface element of a mobile application configured to request vehicle service, an indication to display a photos of one or more of a taxi driver and a taxi vehicle driven by the driver. The method can also include, in response to the receiving, causing to be displayed on a second user interface element, the photo of one or more of a taxi driver and a taxi vehicle driven by the driver.

In some implementations, the taxi driver can be one contracted by a user associated with the mobile application for vehicle service. In some implementations, the taxi driver can be one of one or more taxi drivers available for contract through the mobile application.

The method can further include determining an approximate distance between the taxi vehicle and the user. The method can also include, when the approximate distance is within a threshold, causing a third user interface element to be displayed, wherein the third user interface element shows a photo of the taxi driver and a photo of the taxi vehicle being driven by the driver.

In some implementations, the approximate distance between the user and the taxi vehicle are determined based on location information received from respective position sensing devices in a user device executing the mobile application and a driver device executing a driver mobile application. The photos of one or more of a taxi driver and a taxi vehicle driven by the driver can be provided by a third party different from the taxi driver.

Some implementations can include a system comprising one or more processors coupled to a nontransitory computer readable medium having stored thereon on software instructions that, when executed by the one or more processors, cause to perform operations. The operations can include receiving, from a first user interface element of a mobile application configured to request vehicle service, an indication to display photos of one or more of a taxi driver and a taxi vehicle driven by the driver. The operations can also include in response to the receiving, causing to be displayed on a second user interface element, the photo of one or more of a taxi driver and a taxi vehicle driven by the driver.

In some implementations, the taxi driver can be one contracted by a user associated with the mobile application for vehicle service. In some implementations, the taxi driver is one of one or more taxi drivers available for contract through the mobile application.

The operations can further include determining an approximate distance between the taxi vehicle and the user. The operations can also include, when the approximate distance is within a threshold, causing a third user interface element to be displayed, wherein the third user interface element shows a photo of the taxi driver and a photo of the taxi vehicle being driven by the driver.

The approximate distance between the user and the taxi vehicle can be determined based on location information received from respective position sensing devices in a user device executing the mobile application and a driver device executing a driver mobile application.

The photos of one or more of a taxi driver and a taxi vehicle driven by the driver are provided by a third party different from the taxi driver.

Some implementations can include a nontransitory computer readable medium having stored thereon software instructions that, when executed by one or more processors, cause the one or more processors to perform operations. The operations can include receiving, from a first user interface element of a mobile application configured to request vehicle service, an indication to display photos of one or more of a taxi driver and a taxi vehicle driven by the driver. The operations can also include in response to the receiving, causing to be displayed on a second user interface element, the photo of one or more of a taxi driver and a taxi vehicle driven by the driver.

In some implementations, the taxi driver can be one contracted by a user associated with the mobile application for vehicle service. In some implementations, the taxi driver is one of one or more taxi drivers available for contract through the mobile application.

The operations can further include determining an approximate distance between the taxi vehicle and the user. The operations can also include, when the approximate distance is within a threshold, causing a third user interface element to be displayed, wherein the third user interface element shows a photo of the taxi driver and a photo of the taxi vehicle being driven by the driver.

The approximate distance between the user and the taxi vehicle can be determined based on location information received from respective position sensing devices in a user device executing the mobile application and a driver device executing a driver mobile application.

The photos of one or more of a taxi driver and a taxi vehicle driven by the driver are provided by a third party different from the taxi driver.

Any of the above implementations can also include sending a photo of the user from the mobile application associated with the user to a mobile application associated with the driver. The photo of the user can be acquired by the mobile application prior to pickup by the driver.

### BRIEF DESCRIPTION OF THE DRAWINGS

FIG. 1 shows an example user interface screen in progression to showing a photo of the driver and car in response to input at the user interface in accordance with some implementations.

FIG. 2 shows an example user interface screen in further progression to show the driver and car in response to input at the user interface in accordance with some implementations.

FIG. 3 shows an example user interface screen having a camera icon that permits the user to view a photo of one or more vehicles that may be able to provide service in accordance with some implementations.

FIG. 4 shows an example user interface screen having a camera icon that permits a user to view a photo of one or more vehicles that may be able to provide service as an alternative to the position shown in FIG. 3 in accordance with some implementations.

FIG. 5 shows an example user interface screen displayed when the contracted vehicle is within a specific range of the user in accordance with some implementations.

FIG. 6 is an example computing device configured to provide a computerized vehicle service request system having enhanced safety features in accordance with some implementations.

### DETAILED DESCRIPTION

As used herein, the term “taxi” can include any vehicle that may be used to pick up a passenger utilizing a request system incorporating a mobile or stationary computing device, such as a smart phone or tablet. As used herein, the term “Uber” refers to any company that develops, markets and operates a mobile-app-based transportation network utilizing a mobile app that allows consumers to submit a trip request, which is routed to one or more taxi drivers, which operate their own or leased vehicles in a “crowd-sourced” model.

In general, some implementations can include an improved system and method for requesting an on-demand vehicle service on a mobile or stationary computing device. The improved system and method can include providing a feature that permits a user to view a photo of the pickup vehicle in order to permit identification of the pickup vehicle and improve safety and security for the user. The disclosed improvement may also contribute to a feeling of increased security with users knowing they will be getting into a vehicle that subscribes to the contracted service provider.

Exemplary companies such as Uber as well as other follow-on services of a similar nature have introduced conventional online taxi systems to users. There have been concerns by users about entering vehicles that are not easily recognizable. It is well known that when one requests a taxi from the Yellow Cab Company that the taxi that will pick you up will be yellow with the distinctive rooftop taxi adornment. The newer crowd-sourced vehicle services, such as Uber, may not provide for this level of vehicle recognition. As such, there may be a need to provide enhanced customer security and comfort with getting into a car that does not have the easily recognizable Yellow Taxi look and feel.

One feature of the disclosed improvement can include providing a photo of the pickup vehicle before and/or after a pickup arrangement has been made. Additionally, some implementations can include a method that automatically displays a window showing the vehicle and driver when the pickup vehicle is in close proximity (e.g., within a specified range of the user as determined by the location of the vehicle compared with the location of the user, where the locations of the vehicle and the user may be obtained from respective mobile devices) to the passenger so that the passenger may know the vehicle is near and will readily recognize it. The user may also be able to show the driver a screen that ensures the driver that the passenger entering is indeed the one in contract, e.g., a screen of the vehicle service mobile application that the driver can view and/or scan with the driver's mobile device to verify the correct passenger identity.

Some implementations can include a method of providing enhanced vehicle service user (or passenger) security and an increased level of trust by the user of online taxi reservation systems such as those provided by Uber. Utilizing such improvements may help provide for a greater level of business for the firm using such improvements given that such a high level of effort is directed in marketing campaigns directed at increasing the user awareness of the safety of using such services. There have been some incidents of less than scrupulous people pretending to be vehicle service providers and decreasing the feeling of safety for potential users. Having a means to show the user a photograph of the vehicle as well as the driver may help alleviate allay such concerns. Using improvements as disclosed herein may permit vehicle service companies to focus on education of users that it may be difficult (or nearly impossible) to “hack” such a system that shows the exact car and driver who will pick up the passenger. The disclosed improvement including use of a photo of the pickup vehicle either before, and or after a reservation is made by a passenger to be picked up by an Uber type vehicle.

A clear and easily recognizable photo of the pickup vehicle would be readily available to the user by selecting an icon or making a gesture that can be sensed with the smart device's accelerometer as well as by a voice recognition system to launch the display of the coming vehicle. Additionally, a GPS signal may be used to determine when the vehicle is at a specific “near-distance” that would automatically launch a mode that alerts the passenger that the pickup vehicle is approaching and a photo of the vehicle and or driver is displayed to the passenger.

Additionally, the same screen that alerts the passenger that the car is near may be similarly used to show to the driver to indicate that the passenger entering the vehicle is indeed the one in contract to ride in that vehicle. As much as the passenger may need to feel secure, so too may the driver need to know with whom they are entering into a contract for hire.

In some implementations, GPS signal receivers in the user and driver mobile devices may be used to determine approximate locations of the user and the approaching driver and, when the driver is within a given distance of the user, the user's mobile device can cause a screen to be displayed that alerts the user that the pickup vehicle is in close proximity as well as provide photos of the driver and/or the vehicle or the vehicle and or driver alone.

Also, in some implementations, a user interface element, such as an icon of a camera or photo, may be displayed. When selected, the user interface element can cause photos of the car and or driver of the vehicle before and/or after requesting a pickup. Such an icon may launch various screens wherein one screen may show the closest Uber vehicle and driver and while in that screen the user may select to view other Uber vehicles that may be farther away that might be a more appropriate personal choice for the user. With this facility the user may choose which vehicle driver combination they wish to enter into contract with for service.

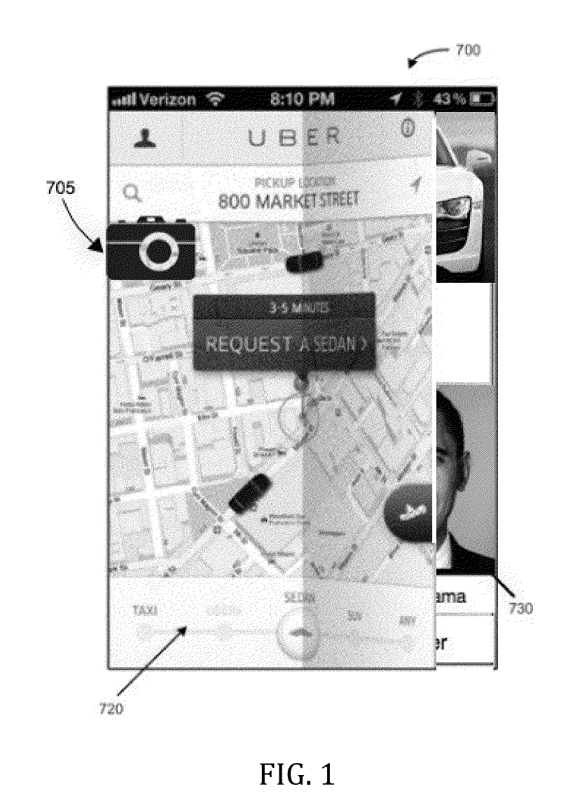

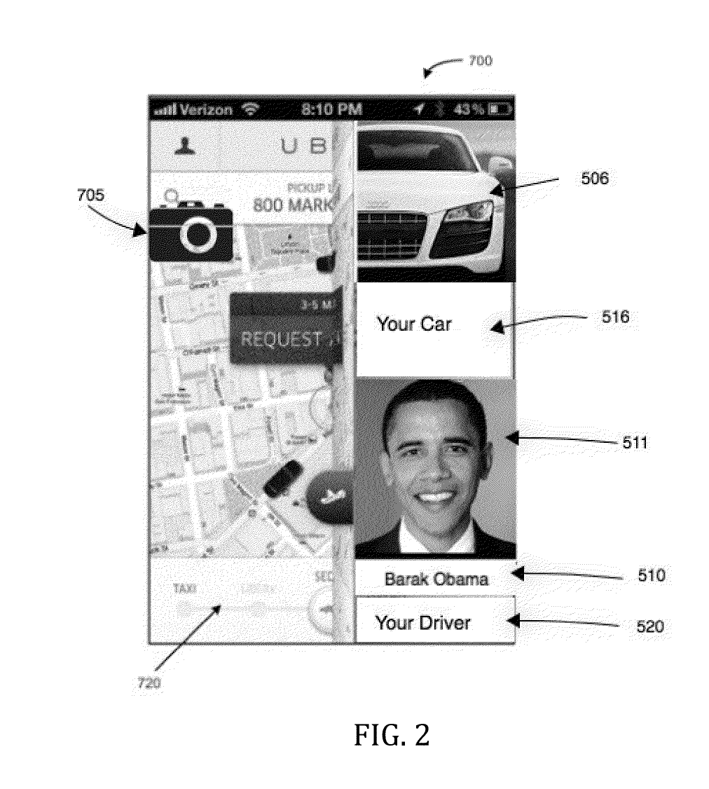

FIG. 1 shows an example user interface screen 700 for a vehicle service user mobile application having a photo icon user interface element 705 that when tapped (or otherwise selected) causes the screen 720 to be yielded (e.g., in a sliding or flipping animation manner shown, or any other suitable manner) to display a screen 730 having driver photo and car photo (shown “peaking” out in view on right side). Such a screen rolls over to expose more as shown in FIG. 2. This functionality may be invoked by tapping (or otherwise selecting) an icon or with a gesture that may be sensed with the on board accelerometer, such as shaking the phone will show the same photos screen 730.

FIG. 2 shows an example user interface screen 700 that with a further progression of the screen 720 in FIG. 1 after the user taps the camera icon 705 to reveal a user interface section displaying a photo of the car 506 a label of the car 516 as well as a photo of the driver 511, the driver name 510 as well as a label (e.g., “Your Driver”) 520.

The photos of the driver and or vehicle can be obtained from the driver (e.g., as part of the profile settings for that driver), or may be obtained from a third party, such as the transportation service provider (e.g., Uber or the like) or from another third party that provides authenticated pictures of the driver and/or vehicle. Additionally, the photos of the driver and/or vehicle may be obtained from a licensing agency such as a department of transportation, vehicles or licensing for a jurisdiction in which the driver is licensed and the vehicle is registered. The third party photos may be stored by the service provider (e.g., Uber) and provided to users by the service provider thereby removing potential for a driver to modify the photos.

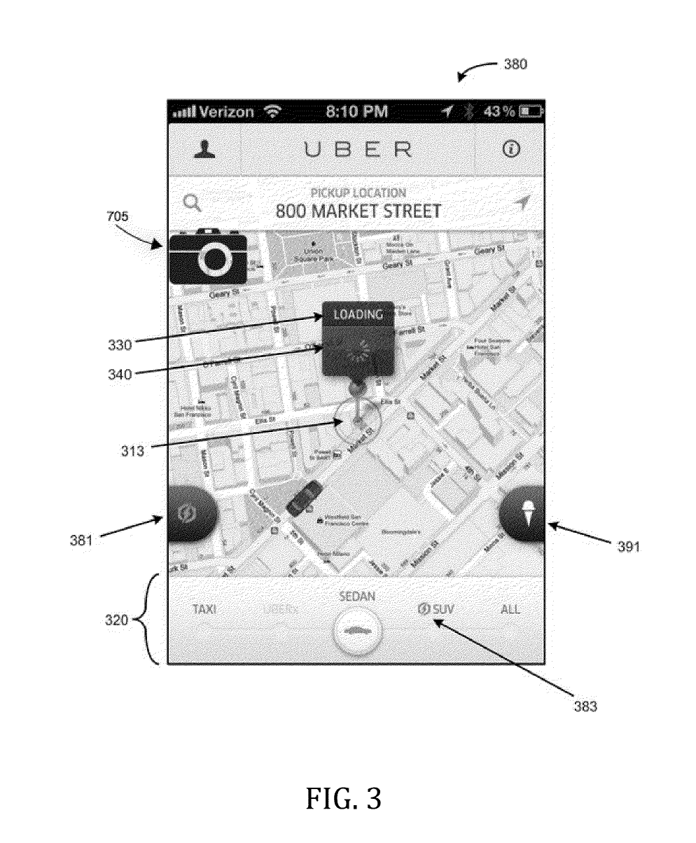

FIG. 3 shows an example user interface screen 380 that features a number of elements common to an Uber type interface screen. A disclosed improvement to this screen is the camera icon 705 that may be tapped (or otherwise selected) to display the photos of any number of cars, or a single car that may be for hire. Various icons may be added to the footer area 320 to accommodate the mode in which the photos may be shown. In one variant the user may choose from a number of vehicles and drivers and choose a specific driver and car combination. This functionality may be invoked by selecting an icon or with a gesture that may be sensed with the on board accelerometer, such as shaking the phone.

In some instances the display can also include a price adjustment selectable feature via the graphic at 381. Vehicles for which the price adjustment feature are associated with may be shown in the footer section with a corresponding vehicle price adjustment icon 383. The map can include a graphic pin 313 that indicates the user's current location or pickup location as well as indicates an estimated time of arrival 330 of an available service provider having a vehicle of the selected type, and a request selection feature 340 to enable the user to request the transport service using the selected vehicle type. The promotional selection feature 391 can be selected by a user to view dynamically provided promotional content that the user can view and request when requesting the transport service.

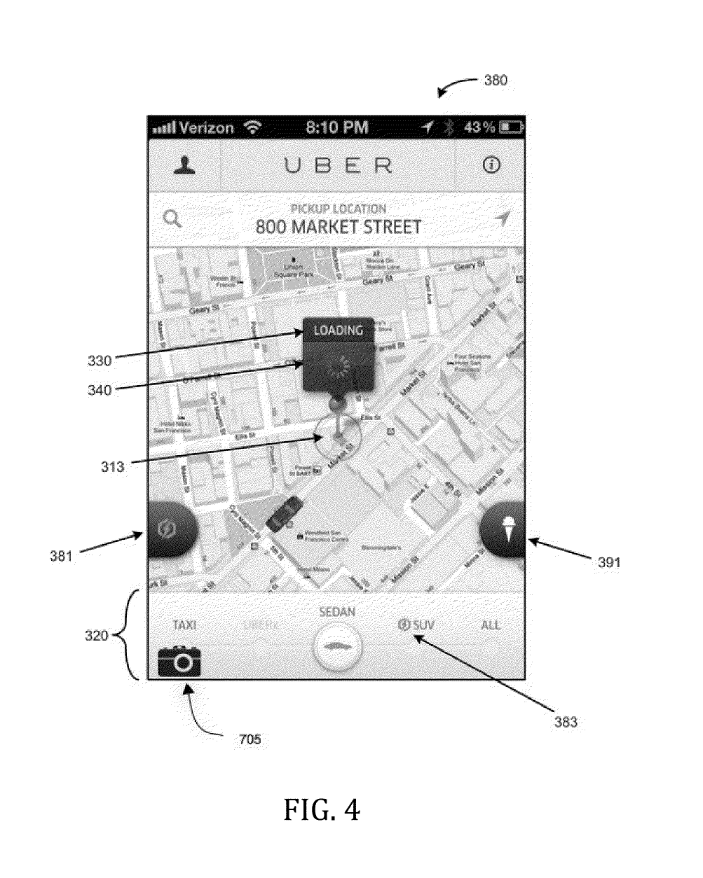

FIG. 4 shows an example user interface screen 380 with the photo icon 705 located in the footer section 320 as an alternative to the position shown in FIG. 3.

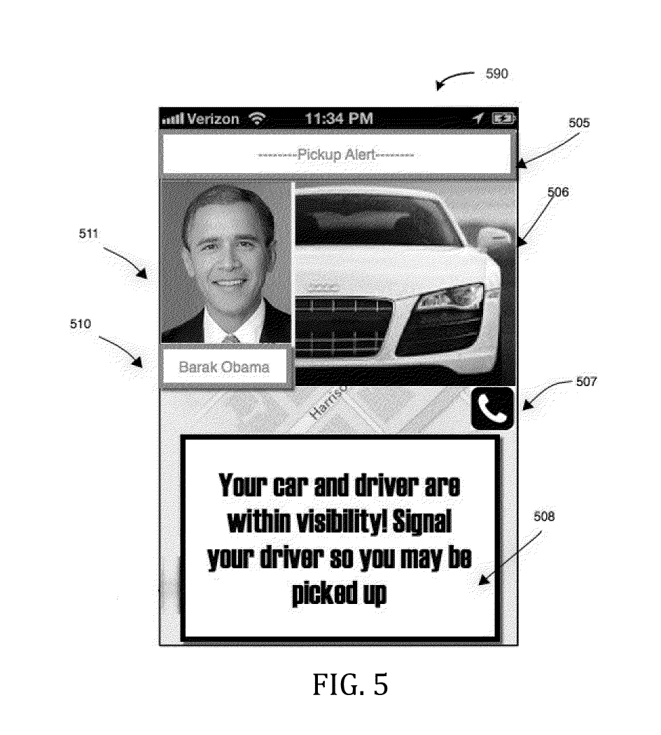

FIG. 5 shows an example user interface screen 590 that may be spawned (or displayed) when the contracted Uber type vehicle is within a specific range of the user (e.g., as determined by GPS functionality contained in smartphone devices of the user and the driver). Utilizing this scheme, the screen 590 would be spawned to show a Pickup Alert 505 that may or may not blink or have special animation as well as emit a sound and/or vibration alerting the user to close proximity of pickup vehicle. A photo of the vehicle is shown in 506 as well as a photo of the driver 511 with the driver name 510. There may be any number of icons such as the phone icon 507 to allow the passenger to contact the driver via phone call. The notice 508 may be dynamic to alert the passenger of the status of the pickup. Such a screen may be shown to the driver to assure the driver that the person entering the vehicle is the one in contract to enter. In other words, the driver may verify the passenger is the contracted passenger by the passenger showing the driver the pickup alert screen having a picture of the driver and the driver's vehicle. In some implementations, the mobile application associated with the user (or passenger) may send a photo of the user to the driver's mobile application to permit the driver to verify the passenger's identity. The mobile application may require the photo of the user to be recent (e.g., acquired within a given time period of the current time). For example, the user mobile application may require the user to take and submit a photo (e.g., at or near the time of requesting a vehicle service, or at or near a pickup time) to send to the driver prior to pickup so that the driver receives current photo of the user to verify the user's identity and to also help the driver identify the user from the street.

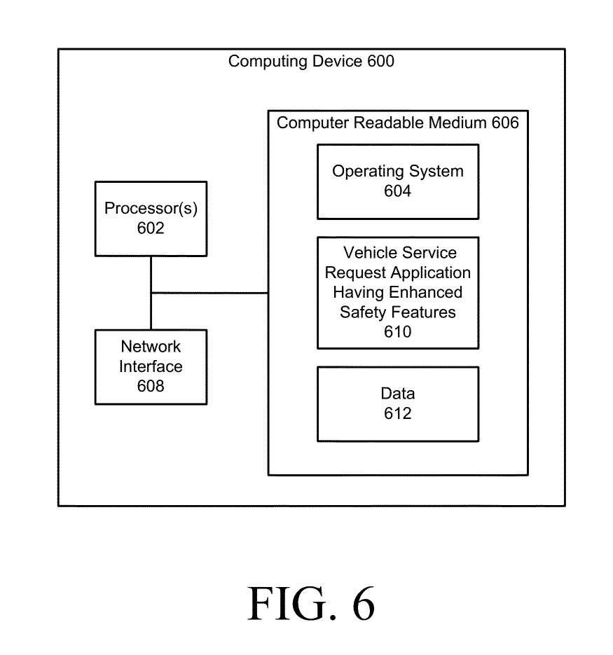

FIG. 6 is a diagram of an example computing device 600 in accordance with at least one implementation. The computing device 600 includes one or more processors 602, nontransitory computer readable medium 606 and network interface 608. The computer readable medium 506 can include an operating system 604, a vehicle service request application having enhanced safety features 610 and a data section 612 (e.g., for storing driver and/or vehicle photos, etc.).

In operation, the processor 602 may execute the application 610 stored in the computer readable medium 606. The application 610 can include software instructions that, when executed by the processor, cause the processor to perform operations for providing a vehicle service request system having enhanced safety features in accordance with the present disclosure.

The application program 610 can operate in conjunction with the data section 612 and the operating system 604.

User devices and driver devices can include one or more of a portable computing device such as a smartphone, wearable computing device (e.g., watch or fitness band), Google Glass-type device, tablet, electronic media player, laptop computer, desktop computer, etc. A server can include a single network server device, a multiprocessor network server device, a distributed computing system, a cloud computing system or the like.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general purpose computer, a special purpose computer, a microprocessor, a network server or switch, or the like.

It is, therefore, apparent that there is provided, in accordance with the various embodiments disclosed herein, methods, systems and computer readable media for computerized vehicle service request systems having enhanced safety features.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A method comprising:
receiving, from a first user interface element of a mobile application configured to request vehicle service, an indication to display a photos of one or more of a taxi driver and a taxi vehicle driven by the driver; and
in response to the receiving, causing to be displayed on a second user interface element, the photo of one or more of a taxi driver and a taxi vehicle driven by the driver.

2. The method of claim 1, wherein the taxi driver has been contracted by a user associated with the mobile application for vehicle service.

3. The method of claim 1, wherein the taxi driver is one of one or more taxi drivers available for contract through the mobile application.

4. The method of claim 2, further comprising:
determining an approximate distance between the taxi vehicle and the user; and
when the approximate distance is within a threshold, causing a third user interface element to be displayed, wherein the third user interface element shows a photo of the taxi driver and a photo of the taxi vehicle being driven by the driver.

5. The method of claim 4, wherein the approximate distance between the user and the taxi vehicle are determined based on location information received from respective position sensing devices in a user device executing the mobile application and a driver device executing a driver mobile application.

6. The method of claim 1, wherein the photos of one or more of a taxi driver and a taxi vehicle driven by the driver are provided by a third party different from the taxi driver.

7. A system comprising:
one or more processors coupled to a nontransitory computer readable medium having stored thereon on software instructions that, when executed by the one or more processors, cause to perform operations including:
receiving, from a first user interface element of a mobile application configured to request vehicle service, an indication to display a photos of one or more of a taxi driver and a taxi vehicle driven by the driver; and
in response to the receiving, causing to be displayed on a second user interface element, the photo of one or more of a taxi driver and a taxi vehicle driven by the driver.

8. The system of claim 7, wherein the taxi driver has been contracted by a user associated with the mobile application for vehicle service.

9. The system of claim 7, wherein the taxi driver is one of one or more taxi drivers available for contract through the mobile application.

10. The method of claim 8, wherein the operations further include:
determining an approximate distance between the taxi vehicle and the user; and
when the approximate distance is within a threshold, causing a third user interface element to be displayed, wherein the third user interface element shows a photo of the taxi driver and a photo of the taxi vehicle being driven by the driver.

11. The method of claim 10, wherein the approximate distance between the user and the taxi vehicle are determined based on location information received from respective position sensing devices in a user device executing the mobile application and a driver device executing a driver mobile application.

12. The method of claim 8, wherein the photos of one or more of a taxi driver and a taxi vehicle driven by the driver are provided by a third party different from the taxi driver.

13. A nontransitory computer readable medium having stored thereon software instructions that, when executed by one or more processors, cause the one or more processors to perform operations including:
receiving, from a first user interface element of a mobile application configured to request vehicle service, an indication to display a photos of one or more of a taxi driver and a taxi vehicle driven by the driver; and
in response to the receiving, causing to be displayed on a second user interface element, the photo of one or more of a taxi driver and a taxi vehicle driven by the driver.

14. The nontransitory computer readable medium of claim 13, wherein the taxi driver has been contracted by a user associated with the mobile application for vehicle service.

15. The nontransitory computer readable medium of claim 13, wherein the taxi driver is one of one or more taxi drivers available for contract through the mobile application.

16. The nontransitory computer readable medium of claim 14, wherein the operations further include:
determining an approximate distance between the taxi vehicle and the user; and
when the approximate distance is within a threshold, causing a third user interface element to be displayed, wherein the third user interface element shows a photo of the taxi driver and a photo of the taxi vehicle being driven by the driver.

17. The nontransitory computer readable medium of claim 16, wherein the approximate distance between the user and the taxi vehicle are determined based on location information received from respective position sensing devices in a user device executing the mobile application and a driver device executing a driver mobile application.

18. The nontransitory computer readable medium of claim 14, wherein the photos of one or more of a taxi driver and a taxi vehicle driven by the driver are provided by a third party different from the taxi driver.

19. The method of claim 8, further comprising sending a photo of the user from the mobile application associated with the user to a mobile application associated with the driver.

20. The method of claim 19, wherein the photo of the user is acquired by the mobile application prior to pickup by the driver.
